(19) United States
(12) Patent Application Publication
(10) Pub. No.: US 2012/0128209 A1
(43) Pub. Date: May 24, 2012

(54) IMAGE ANALYSIS DEVICE AND IMAGE ANALYSIS PROGRAM

(76) Inventors: Shigetoshi Sakimura, Hitachi (JP); Hiroto Morizane, Hitachi (JP); Keisuke Nakashima, Hitachi (JP); Shoji Muramatsu, Hitachinaka (JP)

(21) Appl. No.: 13/381,514

(22) PCT Filed: Jun. 30, 2009
(86) PCT No.: PCT/JP2009/061977

§ 371 Date: Feb. 7, 2012

(51) Int. Cl. G06K 9/00

(52) U.S. Cl. 382/103

(57) ABSTRACT

Problem to be Solved:

To cut down individual development and reduce a design load in image analysis functions with different objects and information to be recognized.

Solution:

An image analysis device for analyzing information on input moving image to output the results of the analysis includes an individual processing section configured to perform processing according to an object to be analyzed to recognize objects included in the moving image and a common processing section configured to subject a plurality of different objects to be analyzed to a common analysis processing based on the results recognized by the individual processing section, in which the individual processing section includes an information extraction section configured to recognize the object included in the moving image according to the object to be analyzed to extract information, a corresponding information storage section configured to store corresponding information showing to which information processed in the common processing section the extracted information corresponds, and a processing result acquisition section configured to acquire the information analyzed and processed by the common processing section.

### TECHNICAL FIELD

The present invention relates to an image analysis device and an image analysis program and, in particular, to a reduction in a design load of the image analysis device.

### BACKGROUND ART

An improvement in the performance of processing of an image recognition system has expanded its application field from an existing FA (Factory Automation) field to various fields such as indoor and outdoor person monitoring, face recognition by a digital camera, and external recognition by a on-vehicle camera.

On the other hand, in the development of an image recognition application program (hereinafter referred to as recognition application) for realizing the functions of the image recognition system, software of the recognition application has been individually developed because objects to be recognized or data to be measured are different for each business field.

FIG. 19 shows an example. FIG. 19 takes an example of traffic flow measurement and person (intruder) monitoring as examples of a business field and shows processing flows for their respective recognition applications. As shown in FIG. 19, for the traffic flow measurement, an image is obtained (S1901) and then a vehicle is detected (S1902), the detected vehicle and the type of the vehicle as its attribute are registered (S1903), information on passage time or speed of the vehicle being behavior information obtained while the vehicle being traced is managed (registered, updated, or deleted) (S1904), and as final recognition results, pieces of information on a distribution of type of the vehicle, passage time, and average vehicle speed are aggregated (S1905).

For the person monitoring, on the other hand, an image is obtained (S1911) and then a person is detected (S1912), the detected person and his/her body-height classification as his/her attribute are registered (S1913), information on intrusion time, walk direction, and person foot position obtained while the person being traced is managed (1914), and as final recognition results, pieces of information on a distribution of the body-height classification, intrusion time, and a distribution of a flow line are aggregated (S1915).

Thus, until now, an object desired to be recognized and information desired to be recognized are different for each business field, so that a system has been individually developed. In the examples shown in FIG. 19, one of the objects desired to be recognized is a vehicle and the other is a person. One of the pieces of information desired to be recognized is a vehicle speed and the other is a flow line.

Until now, a system has been proposed in which data structure is made common provided that the data structure has a common concept high in versatility such as a coordinate (refer to Patent Document 1, for example), while the above-mentioned development system exists. Patent Document 1 discusses an example in which a pan-tilt camera manages a camera coordinate system (two-dimensional space) and a world coordinate system (three-dimensional space) as a standard data structure to perform an interconversion between them.

### Patent Document 1: Japanese Patent Application Laid-Open No. 2007-293717

### SUMMARY OF INVENTION

### Technical Problem

In the conventional method, the data structure can be standardized as far as information which has a common concept as a system for representing an actual time space such as time or coordinate or information in which standards such as a video frame number are provided are concerned. The above common concept includes an SI section, for example. The above standards include NTSC (National Television System Committee), for example.

However, for information without the common concept and standards, data structure and functions for processing the information cannot be made common, so that individual development has been performed for each business field or each system to cause a problem that a design load is high. In particular, in a case where a business field is greatly different from each other, a business world is originally different, so that business-world standards themselves are not compatible with each other, which cannot avoid individual development.

The purpose of the present invention is to cut down individual development and reduce a design load in image analysis functions with different objects and information to be recognized.

### Solution to Problem

According to an aspect of the present invention, an image analysis device for analyzing information on input moving image to output the results of the analysis includes an individual processing section configured to perform processing according to an object to be analyzed to recognize objects included in the moving image and a common processing section configured to subject a plurality of different objects to be analyzed to a common analysis processing based on the results recognized by the individual processing section, in which the individual processing section includes an information extraction section configured to recognize the object included in the moving image according to the object to be analyzed to extract information, a corresponding information storage section configured to store corresponding information showing to which information processed in the common processing section the extracted information corresponds, and a processing result acquisition section configured to acquire the information analyzed and processed by the common processing section.

### Advantage Effects of Invention

The present invention enables cutting down individual development and reducing a design load in image analysis functions with different objects and information to be recognized.

### BRIEF DESCRIPTION OF DRAWINGS

FIG. 1 is a block diagram showing a hardware configuration of an image forming device according to an embodiment of the present invention.

FIG. 2 is a diagram showing the functional configuration of an image analysis device according to the embodiment of the present invention.

FIG. 3 shows the detail of an image analysis section according to the embodiment of the present invention.

FIG. 4 is a chart showing an example of corresponding information according to the embodiment of the present invention.

FIG. 5 is a chart showing an example of corresponding information according to the embodiment of the present invention.

FIG. 6 is a chart showing an example of information stored in an object information storage section according to the embodiment of the present invention.

FIG. 7 is a chart showing an example of information stored in a time information storage section according to the embodiment of the present invention.

FIG. 8 is a chart showing an example of information stored in a space information storage section according to the embodiment of the present invention.

FIG. 9 is a flow chart showing the operation of the image analysis device according to the embodiment of the present invention.

FIG. 10 is a flow chart showing an analysis type definition processing according to the embodiment of the present invention.

FIG. 11 is a flow chart showing an invariant attribute registration processing according to the embodiment of the present invention.

FIG. 12 is a flow chart showing a time-series attribute registration processing according to the embodiment of the present invention.

FIG. 13 is a flow chart showing a recognition result analysis processing according to the embodiment of the present invention.

FIG. 14 is a chart showing an example of an analysis result display screen according to the embodiment of the present invention.

FIG. 15 is a flow chart showing a recognition result analysis processing according to another embodiment of the present invention.

FIG. 16 is a chart showing an example of an analysis result display screen according to another embodiment of the present invention.

FIG. 17 is a chart showing an effect according to the embodiment of the present invention.

FIG. 18 is a block diagram showing the detail of an image analysis section according to another embodiment of the present invention.

FIG. 19 is a flow chart showing an example of an image analysis device according to a conventional technique.

### DESCRIPTION OF EMBODIMENTS

### First Embodiment

An embodiment of the present invention will be described in detail below with reference to drawings. In the present embodiment, an image analysis device will be described in which captured moving image information is analyzed to output various analysis results. Incidentally, in the present embodiment, a case where a single device includes all functions related to image analysis will be described as an example, however, processing can be distributed to a plurality of devices connected via a network.

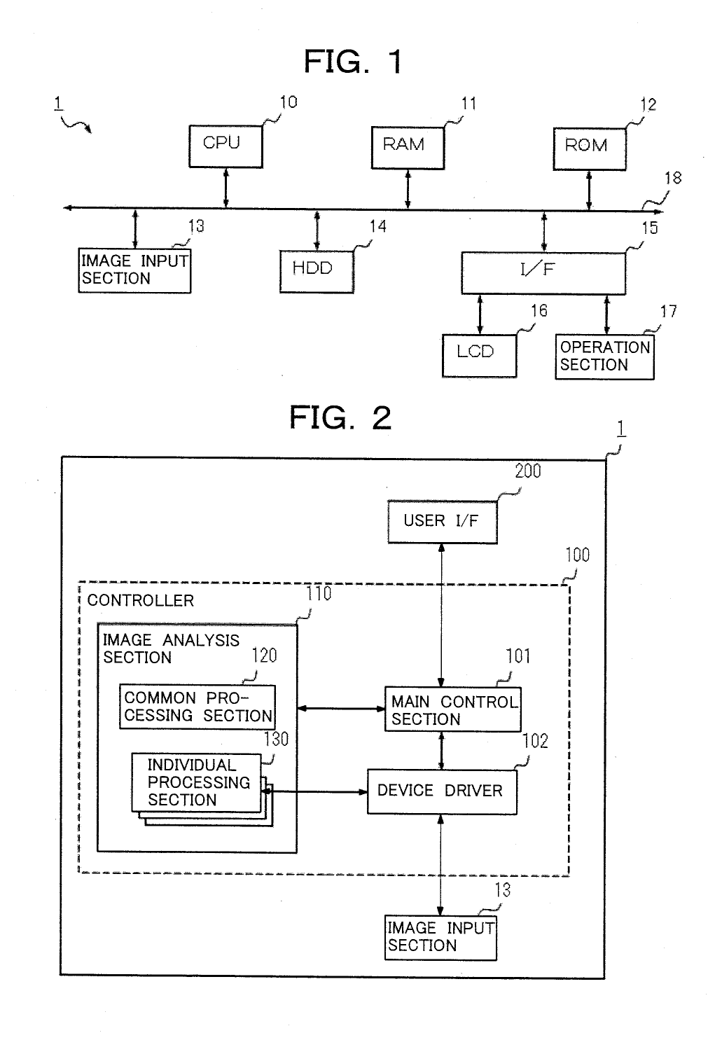

FIG. 1 is a block diagram showing a hardware configuration of an image analysis device according to the present embodiment. As shown in FIG. 1, the image analysis device 1 according to the present embodiment is similar in configuration to an information processing terminal such as a general server and a PC (Personal Computer) and includes an image input section for capturing a moving image as well. More specifically, the image analysis device 1 according to the present embodiment connects a CPU (Central Processing Section) 10, a RAM (Random Access Memory) 11, a ROM (Read Only Memory) 12, an image input section 13, a HDD (Hard Disk Drive) 14, and an I/F 15 with each other via a bus 18. The I/F 15 is connected with an LCD (Liquid Crystal Display) 16 and an operation section 17.

The CPU 10 is a calculation section and controls the operation of the entire image analysis device 1. The RAM 11 is a volatile storage medium capable of reading and writing information at a high speed. The RAM 11 is used as a working area when the CPU 10 processes information. The ROM 12 is a read-only nonvolatile storage medium and stores a program such as firmware. The image input section 13 is an imaging device such as a camera, for converting optical information to an electric signal and inputting the electric signal to the image analysis device 1. The image input section 13 may be an information input section for inputting information on an already generated still or moving image.

The HDD 14 is a nonvolatile storage medium capable of reading and writing information and stores various control programs such as an OS (Operating System) and application programs. The I/F 15 connects the bus 18 with various hardware devices and networks and performs control. The LCD 16 is a visual user interface for a user confirming the state of the image analysis device 1. The operation section 17 is a user interface such as a keyboard or a mouse for the user inputting information to the image analysis device 1.

The hardware configuration shown in FIG. 1 is an example and the image analysis device according to the present embodiment can be realized by other configurations. For example, the user interfaces such as the LCD 16 and the operation section 17 are removed and the image analysis device can be configured as a server independent of the operation of the user. The HDD 14 and the ROM 12 are merely examples of storage media and other types of storage media may be used.

In such a hardware configuration, the programs stored in the ROM 12 and the HDD 14 or a storage media such as a optical disk which is not shown are read by the RAM 11 and operated by the control of the CPU 10 to configure a software control section. The thus configured software control section is combined with hardware to configure a functional block for realizing the functions of the image analysis device 1 according to the present embodiment.

A functional configuration of the image analysis device 1 according to the present embodiment will be described below with reference to FIG. 2. FIG. 2 is a block diagram showing the functional configuration of the image analysis device 1 according to the present embodiment. As shown in FIG. 2, the image analysis device 1 according to the present embodiment includes a controller 100, a user I/F 200, and the image input section 13. The controller 100 includes a main control section 101, a device driver 102, and an image analysis section 110. Further, the image analysis section 110 includes a common processing section 120 and an individual processing section 130.

The user I/F 200 is an interface for the user operating the image analysis device 1 or obtaining information from the image analysis device 1 and is comprised of the LCD 16 and the operation section 17 shown in FIG. 1.

The controller 100 is formed by combining software with hardware. More specifically, the controller 100 is formed of the software control section in which the control program such as firmware stored in a nonvolatile storage media such as the ROM 12 or a nonvolatile memory and the HDD 14 or an optical disk is loaded on a volatile memory (hereinafter referred to as memory) such as the RAM 11 and controlled by the CPU 10 and hardware such as an integrated circuit. The controller 100 functions as a control section for controlling the entire image analysis device 1.

The main control section 101 plays the role of controlling each section included in the controller 100, gives a command to each section of the controller 100, and transfers information with the user I/F. The device driver 102 is configured to control various hardware devices connected to the image analysis device 1 and control the image input section 13 being a camera in the present embodiment. The device driver 102 according to the present embodiment generates information on a moving image based on the captured information which is converted to an electric signal by the image input section 13.

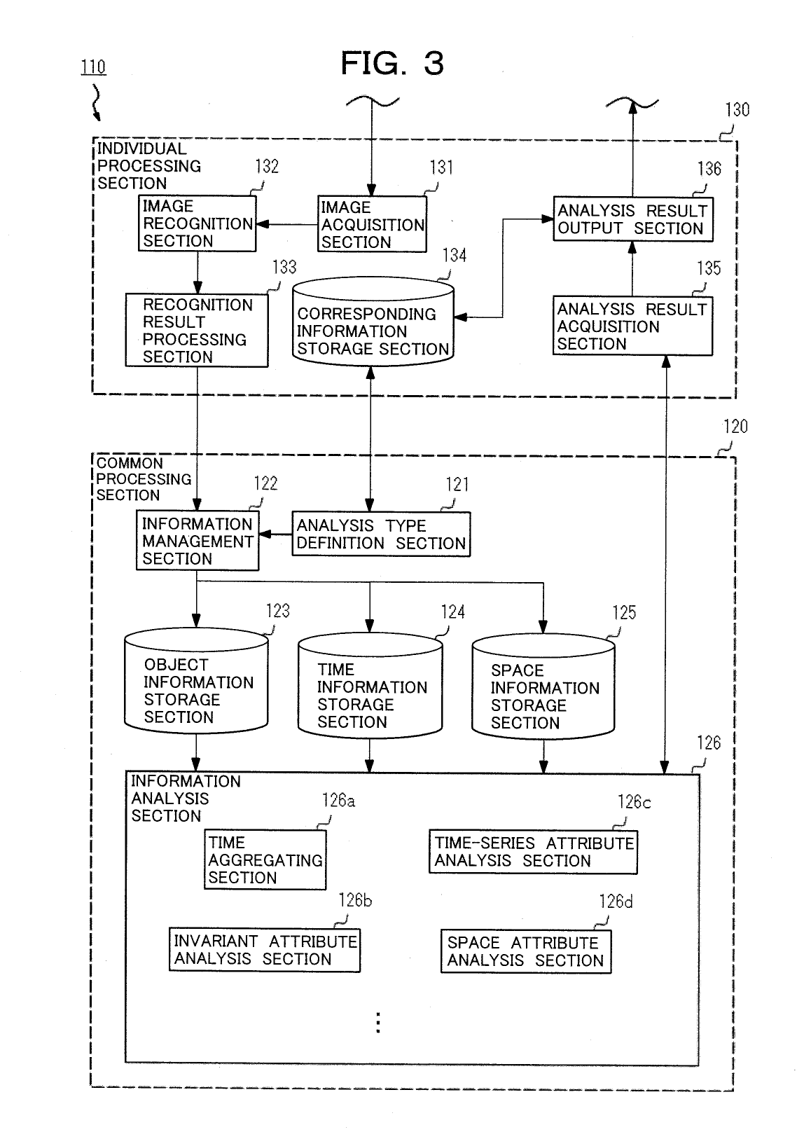

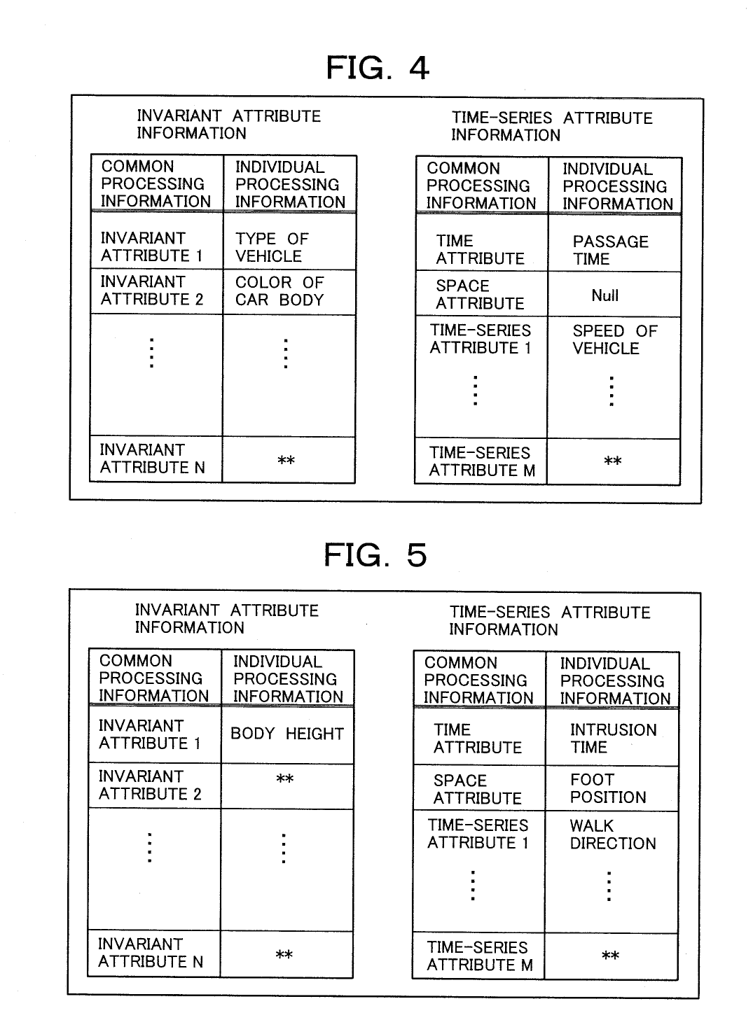

The image analysis section 110 analyses information on the moving image captured by the image input section 13 and generated by the device driver 102 and outputs analyzed results. As described above, the image analysis section 110 includes the common processing section 120 and the individual processing section 130. As shown in FIG. 2, a plurality of the individual processing sections 130 is provided to respond to a different analysis object or system. FIG. 3 shows further in detail the image analysis section 110 according to the present embodiment.

FIG. 3 shows the functional configuration of the common processing section 120 and the individual processing section 130. FIG. 3 also shows the functional configuration that a plurality of the individual processing sections 130 commonly has. As shown in FIG. 3, the common processing section 120 includes an analysis type definition section 121, an information management section 122, an object information storage section 123, a time information storage section 124, a space information storage section 125, and an information analysis section 126. The individual processing section 130 includes an image acquisition section 131, an image recognition section 132, a recognition result processing section 133, a corresponding information storage section 134, an analysis result acquisition section 135, and an analysis result output section 136.

The function of the individual processing section 130 will be described below. The image acquisition section 131 acquires information on the moving image generated by the device driver 102. The image acquisition section 131 inputs the acquired information on the moving image to the image recognition section 132. The image recognition section 132 extracts an object to be recognized included in the moving image based on the information on the moving image input from the image acquisition section 131. In other words, the image recognition section 132 functions as an information extraction section.

The object to be recognized is different according to the application of the image analysis device 1. In the case of traffic flow measurement, a vehicle is an object to be recognized. In the case of person monitoring, a person is an object to be recognized. Thus, the individual processing section 130 is configured for each of various applications of the image analysis device 1, so that a plurality of the individual processing sections 130 is provided as shown in FIG. 2. The image recognition section 132 inputs information on results obtained by analyzing information on a moving image to recognize an object to be recognized to the recognition result processing section 133.

The recognition result processing section 133 processes results recognized by the image recognition section 132 to generate information to be analyzed in the common processing section 120. In the case of traffic flow measurement, for example, information is generated such as “type of a vehicle,” “passage time,” and “speed of the vehicle.” In the case of person monitoring, information is generated such as “body height,” “intrusion time,” “foot position,” and “walk direction.” In other words, the recognition result processing section 133 also functions as an information extraction section. The information generated by the recognition result processing section 133 are separated into invariant attribute information which is successively invariant and only one of which is generated for each object and time-series attribute information which is successively changed and a plurality of which is generated for each object. In the case of the foregoing traffic flow measurement, “type of the vehicle” is the invariant attribute information, and “passage time” and “speed of the vehicle” are the time-series attribute information. In the case of person monitoring, “body height” is the invariant attribute information, and “intrusion time,” “foot position,” and “walk direction” are the time-series attribute information. The recognition result processing section 133 inputs the generated information to the information management section 122 in the common processing section 120.

The corresponding information storage section 134 stores corresponding information showing which of a plurality of types of information processed by the common processing section 120 each information generated by the recognition result processing section 133 corresponds to. An example of information stored in the corresponding information storage section 134 is shown with reference to FIGS. 4 and 5. FIG. 4 is a chart showing an example of information stored in the corresponding information storage section 134 in the case of the traffic flow measurement.

As shown in FIG. 4, the corresponding information storage section 134 stores the corresponding information with the invariant attribute information separated from the time-series attribute information. For the invariant attribute information, a plurality of pieces of information such as an invariant attribute 1, an invariant attribute 2, . . . , and an invariant attribute N is defined. In FIG. 4, the invariant attribute 1 is associated with “type of the vehicle” and the invariant attribute 2 is associated with “color of car body.” For the time-series attribute information, information such as a time attribute, a space attribute, a time-series attribute 1, a time-series attribute 2, . . . , and a time-series attribute N is defined. In FIG. 4, the time attribute is associated with “passage time” and the time-series attribute 1 is associated with “speed of the vehicle.” The space attribute is associated with nothing, that is, a null value.

FIG. 5 a chart showing an example of information stored in the corresponding information storage section 134 in the case of the person monitoring. As shown in FIG. 5, the invariant attribute 1 is associated with “body height.” The time attribute is associated with “intrusion time,” the space attribute is associated with “foot position,” and the time-series attribute 1 is associated with “walk direction.”

The analysis result acquisition section 135 acquires information analyzed by the common processing section 120 and inputs the information to the analysis result output section 136. In other words, the analysis result acquisition section 135 acts as a processing result acquisition section for acquiring information on results processed by the common processing section 120. The analysis result output section 136 converts information on the results analyzed by the common processing section 120 to information that the user can browse and outputs the information. In other words, the analysis result output section 136 generates display information for the user browsing the results analyzed by the common processing section 120.

The common processing section 120 will be described below. The analysis type definition section 121 acquires corresponding information from the corresponding information storage section 134 and defines the type of analysis of information input from the individual processing section 130. The analysis type definition section 121 performs definition for the information management section 122. In other words, the analysis type definition section 122 instructs the information management section 122 to recognize a plurality of types of information input from the recognition result processing section 133 as what type of information.

The information management section 122 causes any of the object information storage section 123, the time information storage section 124, and the space information storage section 125 to store the information input from the recognition result processing section 133 based on the corresponding relationship of information defined by the analysis type definition section 121. The information stored in the object information storage section 123, the time information storage section 124, and the space information storage section 125 is will be below.

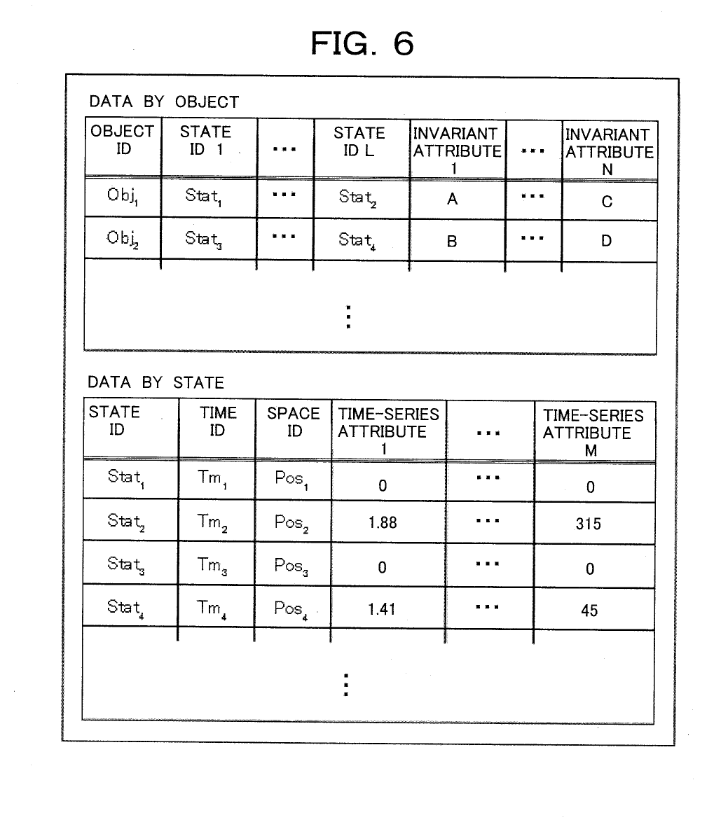

FIG. 6 is a chart showing an example of the information stored in the object information storage section 123. As shown in FIG. 6, the object information storage section 123 includes data by object and data by state. The data by object are the ones in which individual information for each object recognized in a moving image is accumulated and are associated with a plurality of state IDs for identifying time-series state of an object and a plurality of pieces of the invariant attribute information for each object ID for identifying each object.

The state ID holds a corresponding relationship with the data by state described later and can manage a plurality of states of one object. In FIG. 6, a case where L pieces of state per one object are managed is taken as an example. An invariant attribute is an area for holding universal information which an object stationarily has when one object is determined. The invariant attribute refers to information which is not changed in time series form, such as, for example, type of a vehicle or a license plate number in a case where the object is a vehicle and body height or gender in a case where the object is a person.

The data by state are the ones accumulated for each state included in the data by object and are associated with time ID for identifying the time of a state and space ID for identifying the position of an object in the state for each state ID included also in the data by object. Furthermore, the data by state are associated with a plurality of pieces of time-series information described in FIGS. 4 and 5 as information showing each specific state.

The state ID is an identifier for identifying the state of an object. The time ID holds a corresponding relationship with time information described later and represents time when the object exists. The space ID holds a corresponding relationship with space information described later and represents position where the object exists. A time-series attribute is an area for holding information which is changed in time series form according to the state where the object exists when one object is determined. The time-series attribute refers to information which is changed in time series form, such as, for example, momentary speed in a case where the object is a vehicle and walk direction in a case where the object is a person.

In the present embodiment, a moving image processing is taken as an example, so that information shown by a group of states of an object about the same object is a time-series state log meaningful in the order of arrangement, however, this does not limit the recognition application in the present invention. In the case of an application for a visual inspection of components in FA, only one state of an object corresponding to one inspection image in which one object to be inspected is captured is registered to allow the recognition application to be applied also to the FA field. In other words, the configuration and effect of the present invention are not limited to the moving image processing, but applicable to the still image processing.

It is also possible to process information to be substantially processed as the invariant attribute such as height of a vehicle as the time-series attribute. This is particularly effective in the case where a changing process of information which is possibly changed due to erroneous recognition is desired to be observed while the object is being traced.

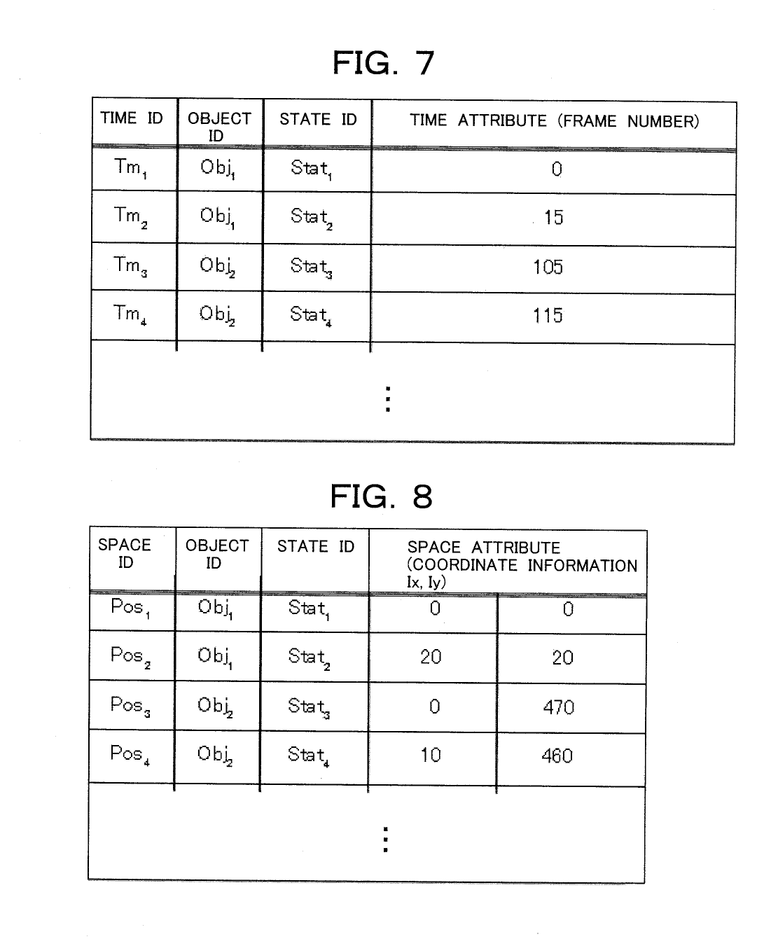

FIG. 7 is a chart showing an example of time information stored in the time information storage section 124. As shown in FIG. 7, the time information storage section 124 associates the object ID showing that what object the time is related to and the state ID showing that what state the time is related to with each time ID included in the data by state in FIG. 6. The object ID and the state ID stored in the time information storage section 124 correspond to the object ID and the state ID described in FIG. 6 respectively.

Furthermore, the time information storage section 124 associates information on the time attribute described in FIGS. 4 and 5 as information showing each time in detail. As shown in FIG. 7, information on the time attribute according to the present embodiment is shown by a frame number of a moving image. The moving image is composed of a plurality of continuous frames, i.e., one frame of a still image. Time series of an image can be represented by a frame number showing the numerical order of each frame. Actual time of a moving image can be obtained from actual time in a reference frame and the frame rate (fps: frame per second) of the moving image.

The time ID is an identifier for identifying time information. The object ID and the object state ID hold a corresponding relationship between the above object information and the state information. The frame number is associated with the state information to allow representing what time the state of the object refers to.

In the present exemplary embodiment, the frame number is used as information meaning time, however, other information may be used provided that it means time. If a field number in the NTSC standard is put in, for example, the resolution of representing time is doubled. Actual time shown by year YYYY, month MM, day DD, hour H, minute M, second S, and ms XXms may be held instead of video time such as the frame number or the field number. Alternatively, the video time and the actual time may be converted to each other by holding both of the video time and the actual time. Such a mode enables transparently processing the information showing time and actual time in the moving image.

FIG. 8 is a chart showing an example of information stored in the space information storage section 125. As shown in FIG. 8, the space information storage section 125 associates the object ID showing that the position of what object the space or the position shows and the state ID showing that the position of what state the position shows with each space ID included in the data by state in FIG. 6. In other words, the space information storage section 125 functions as a position information storage section. The object ID and the state ID stored in the space information storage section 125 correspond to the object ID and the state ID described in FIG. 6 respectively.

Furthermore, the space information storage section 125 associates information on the space attribute described in FIGS. 4 and 5 as information showing each space or position in detail. As shown in FIG. 8, information on the space attribute according to the present embodiment is shown by the coordinate in the still image being one frame of the moving image.

The space ID is an identifier for identifying space information. The object ID and the state ID hold a corresponding relationship between the above object information and the state information. Image coordinate values Ix and Iy being information on the space attribute show that where the space information refers to in the image and are associated with the state information, thereby enabling representing that where the state of the object refers to.

In the present embodiment, the image coordinate values Ix and Iy are used as information meaning position, however other information may be used provided that it means space. For example, the coordinate values of the actual space (hereinafter referred to as world coordinate) being the coordinate values X, Y, and Z in the three dimensional actual space in which a reference position and axial direction are determined may be held instead of the two dimensional image coordinate values. Alternatively, both of the image coordinate and the world coordinate are held and pre-processing such as camera calibration is performed, thereafter the image coordinate and the world coordinate may be converted to each other. A known method may be used for the mutual conversion between the image coordinate and the world coordinate. Such a mode enables transparently processing a position in the image and an actual position.

Thus, in the image analysis device 1 according to the present embodiment, as shown in the data by state in FIG. 6, the information extracted from the moving image is divided into concept being “state” and information on “object,” “time,” and “space” with respect to each state is allocated to the object information storage section 123, the time information storage section 124, and the space information storage section 125 and stored. Information to be analyzed in image analysis is generally any of the above three pieces of information, so that a mode of managing information on “object,” “time,” and “space” is desirable as described above in a case where a device is made general-purpose.

Such a mode allows an analysis function to be previously defined in the common processing section 120 from the aspects of “object,” “time,” and “space” to enable preferably achieving a purpose of cutting down the individual development. For the information stored as the above “object,” as shown in the data by object in FIG. 6, information showing “state” changing in time series form and information showing the invariant attribute being unchanged are stored.

The information management section 122 executes the processing for allocating the information input by the recognition result processing section 133 to the object information storage section 123, the time information storage section 124, and the space information storage section 125 as shown in FIGS. 6 to 8 based on the definition processing performed by the analysis type definition section 121.

The information analysis section 126 performs various analyses based on the information stored in the object information storage section 123, the time information storage section 124, and the space information storage section 125. As shown in FIG. 3, the information analysis section 126 includes a time aggregating section 126a, an invariant attribute analysis section 126b, a time-series attribute analysis section 126c, and a space attribute analysis section 126d.

The time aggregating section 126a sorts the information stored in the time information storage section 124 by the time attribute, or the frame number. The invariant attribute analysis section 126b follows in sequence the object ID in the time information sorted by the time aggregating section 126a and analyzes the invariant attribute of each object with reference to the object information storage section 123. The mode analyzed by the invariant attribute analysis section 126b includes the analysis of distribution for each invariant attribute.

The time-series attribute analysis section 126c follows in sequence the object ID in the time information sorted by the time aggregating section 126a and analyzes the time-series attribute of each object with reference to the object information storage section 123. The mode analyzed by the time-series attribute analysis section 126c includes the analysis of aging and mean value of the time-series attribute.

The space attribute analysis section 126d sorts the information stored in the space information storage section 125 based on the space attribute or the coordinate information. The space attribute analysis section follows in sequence the object ID in the sorted space information and analyzes the distribution of the space attribute and the time-series attribute of each object with reference to the object information storage section 123. The mode analyzed by the space attribute analysis section 126d includes the analysis of movement path of each object and the analysis of a change in the time-series attribute for each position of each object.

FIG. 3 shows the time aggregating section 126a, the invariant attribute analysis section 126b, the time-series attribute analysis section 126c, and the space attribute analysis section 126d as an example of an analysis function includes in the information analysis section 126, however, modes for analyzing information are diverse, so that the modes, which can be analyzed based on the information stored in the object information storage section 123, the time information storage section 124, and the space information storage section 125, can be realized.

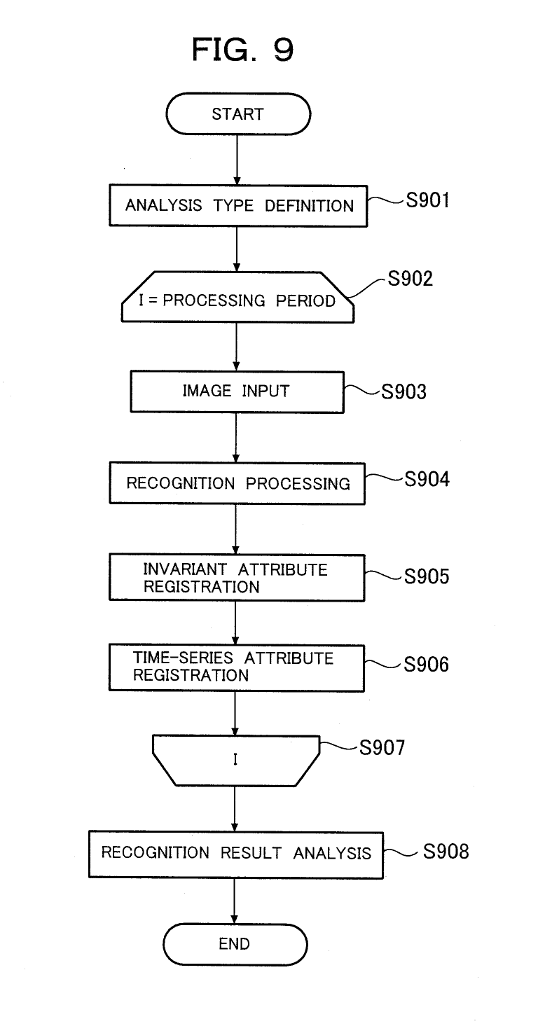

The operation of the image analysis device 1 according to the present embodiment will be described below. FIG. 9 is a flow chart showing the operation of the entire image analysis device 1 according to the present embodiment. As shown in FIG. 9, the image analysis device 1 executes the analysis type definition as a pre-processing for inputting a moving image (S901). In this processing, as described in FIG. 3, the analysis type definition section 121 reads corresponding information from the corresponding information storage section 134 to define a corresponding relationship of information with the information management section 122.

The processing proceeds to a repetitive processing for each processing period (S902 to S907). The processing period refers to a series of periods from the input of an image to a processing for recognition and the display of results and a period conforming to video standards such as 100 ms, for example, in the present embodiment. Within the repetitive processing, the image acquisition section 131 acquires information on a moving image (S903) and the image recognition section 132 performs recognition processing (S904).

The recognition processing refers to algorithm different depending on an object to be recognized or information to be recognized and is individually developed for each of different individual processing sections 130 as described above. In other words, a known method may be used for the image input processing and the recognition processing. For example, for the traffic flow measurement, there is a method in which an image with 640×480 pixels is input for a period of 100 ms to detect a vehicle by a background difference processing being the recognition processing. In the processing in S904, the recognition result processing section 133 generates various pieces of information to be recognized in the common processing section 120 and inputs information on processing results to the information management section 122.

In an invariant-attribute registration processing, the information management section 122 registers the object ID and the invariant attribute information in the object information storage section 123 (S905). In a time-series attribute management processing, the information management section 122 registers the state ID, the time ID, the space ID, the time-series attribute information, the time attribute information, and the space attribute information in the object information storage section 123, the time information storage section 124, and the space information storage section 125 respectively.

A moving image is input and processed for each predetermined processing period “I.” When a prepared moving image is finished or the user issues instructions for finishing the processing in the case of real-time moving image of a camera, the information analysis section 126 analyzes the recognition result using a predetermined calculation method in the recognition result analysis processing (S908). The operation of the image analysis device 1 according to the present embodiment is completed by the above processing.

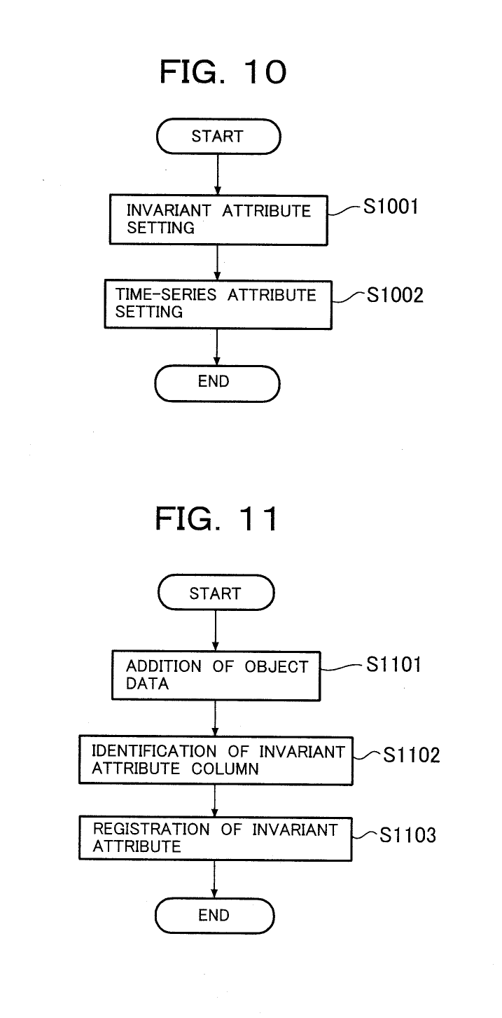

The analysis type definition processing in S901 will be described in detail below with reference to FIG. 10. FIG. 10 is a flow chart showing the detail of the analysis type definition processing in S901. As shown in FIG. 10, the analysis type definition section 121 reads corresponding information on the invariant attribute from the corresponding information storage section 134 to allocate the information corresponding to the invariant attribute among specific information to be analyzed to the invariant attributes 1 to N (S1001). Similarly, the analysis type definition section 121 allocates the information changing in time series form among specific information to be analyzed to the time-series attributes 1 to M (S1002).

The invariant-attribute registration processing in S905 will e described in detail below with reference to FIG. 11. As shown in FIG. 11, the information management section 122 registers the object detected in the recognition processing in S904 in the data by object in the object information storage section 123 (S1101). This adds one datum representing one object to the data by object in the object information storage section 123.

The information management section 122 identifies which area in the data by object in the object information storage section 123 stores the invariant attribute information recognized in the recognition processing in S904 based on the corresponding relationship among the invariant attributes 1 to N defined by the analysis type definition section 121 (S1102). The information management section 122 stores the invariant attribute information recognized in the recognition processing in S904 in an invariant-attribute area identified in S1102 (S1103).

For the traffic flow measurement, for example, if we suppose that a compact car is detected in the recognition processing, the individual processing section 130 delivers the detected information as specific information that “type of a vehicle=a compact car” for each object to be recognized to the information management section 122.

On the other hand, the information management section 122 handles specific information for each object to be recognized not as it is, but in an abstracted form being the invariant attribute. At this point, there is a plurality of areas 1 to N for holding the invariant attribute, so that the information management section 122 determines an appropriate area from among the plurality of areas based on the definition processing performed by the analysis type definition section 121. By the above processing, the common processing section 120 can process information on the invariant attribute for each of a plurality of different objects to be analyzed by a common information format.

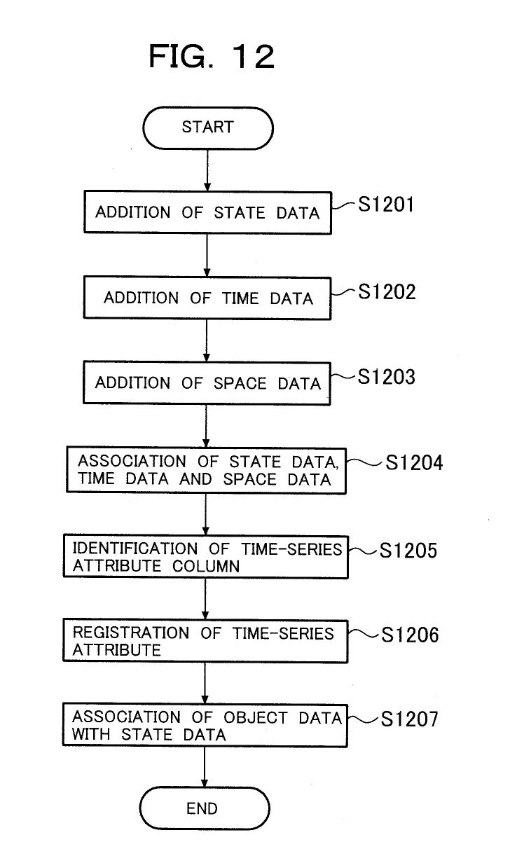

The time-series attribute registration processing in S906 will be described in detail below with reference to FIG. 12. As shown in FIG. 12, the information management section 122 registers the state of the object detected in the recognition processing in S904 in the data by state in the object information storage section 123 (S1201). This adds one datum representing one state of the object to the data by state in the object information storage section 123.

The information management section 122 adds time information to the time information storage section 124 to store information on time represented by the state of the object, i.e., the frame number (S1202). Furthermore, the information management section 122 adds space information to the space information storage section 125 to set information on the coordinate value represented by the state of the object (S1203). The information management section 122 associates time information, space information, and the data by state with one another (S1204). The processing in S1204 is the one for setting the same state ID to each information added in S1201 to S1203. The processing up to S1204 determines when and where the added state of the object refers to.

The information management section 122 identifies which area in the data by state in the object information storage section 123 stores the time-series attribute information recognized in the recognition processing in S904 based on the corresponding relationship among the time-series attributes 1 to M defined by the analysis type definition section 121 (S1205). The information management section 122 stores the recognition information delivered from the individual processing section 130 in any of areas of the time-series attribute identified in S1205 (S1206).

For example, if the recognition result processing section 133 measures the momentary speed of a vehicle, i.e., the speed of a vehicle in the traffic flow measurement, the recognition result processing section 133 delivers the measured information as specific information to be analyzed that “the speed of a vehicle=40 Km/h” to the information management section 122. On the other hand, the information management section 122 with the information delivered handles the specific information to be analyzed not as it is, but in an abstracted form being the time-series attribute. At this point, there is a plurality of areas 1 to M for holding the time-series attribute, so that the information management section 122 determines an appropriate area from among the plurality of areas based on the definition processing performed by the analysis type definition section 121. By the above processing, the common processing section 120 can process information on the time-series attribute for each of a plurality of different objects to be analyzed by a common information format.

Finally, the information management section 122 associates the data by object with the data by state (S1207). The processing in S1207 is the one for setting the state ID commonly provided for the data by state of the object information storage section and each of the time information storage section and the space information storage section 125 in S1204 to the state ID in the data by object in the object information storage section 123. This determines how the object exists.

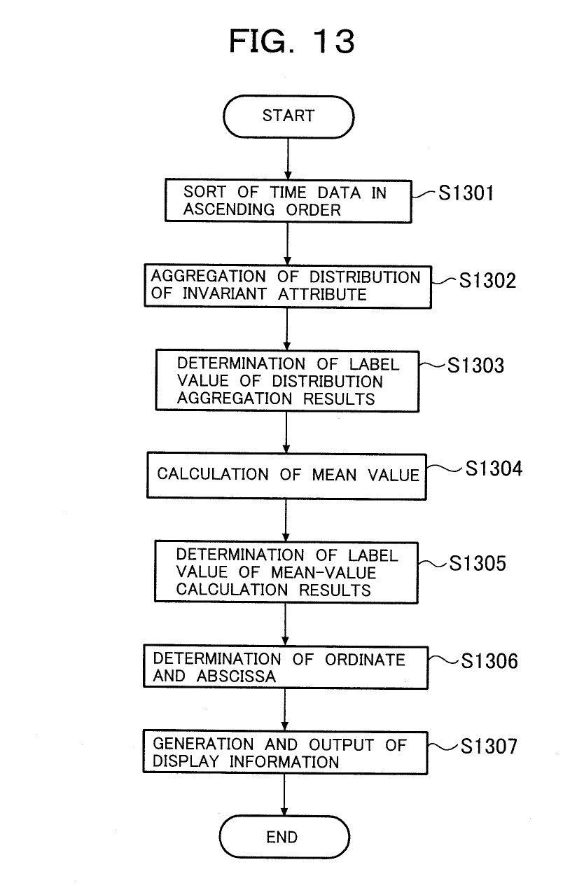

The analysis processing for the recognition results in S908 will be described in detail below with reference to FIG. 13. FIG. 13 is a flow chart showing the analysis processing in the traffic flow measurement. As shown in FIG. 13, the time aggregating section 126a sorts in ascending order the information stored in the time information storage section 124 (S1301). The invariant attribute analysis section 126b refers in order to the object ID of the time information sorted in S1301 to aggregate the distribution of the invariant attribute of the data by object corresponding to the object ID (S1302). Thereafter, the analysis result acquisition section 135 in the individual processing section 130 acquires the information aggregated in S1302. The analysis result output section 136 determines the label value of a distribution aggregation result based on corresponding information stored in the corresponding information storage section 134 (S1303).

For example, in the traffic flow measurement, specific information to be analyzed being “type of a vehicle” is allocated to the invariant attribute 1, so that the time-series distribution of information on the type of a vehicle held in the invariant attribute 1 is aggregated and then a label of “type of a vehicle” is attached to the aggregation result.

The time-series attribute analysis section 126c refers in order to the state ID of the time information sorted in S1301 to calculate the mean value of the time-series attribute of the data by state corresponding to the state ID (S1304). Thereafter, the analysis result acquisition section 135 in the individual processing section 130 acquires the information calculated in S1302. The analysis result output section 136 determines the label value of a mean value calculation result based on the corresponding information stored in the corresponding information storage section 134 (S1305).

In the present embodiment, for example, specific information to be analyzed being “type of a vehicle” is allocated to the time-series attribute 1. Therefore, the time-series attribute analysis section 126c calculates the mean value of information on the speed of a vehicle (momentary speed, to be exact) held in the time-series attribute 1 with respect to one vehicle to obtain the average speed of the vehicle and aggregate the time-series distribution of the average speed of each vehicle. The analysis result output section 136 attaches a label of “speed of a vehicle” to the aggregation result.

The analysis result output section 136 sets the ordinate and the abscissa of a graph (S1306) and generates and outputs display information for displaying a graph (S1307). For example, in the traffic flow measurement, the analysis result output section 136 determines a corresponding relationship that the ordinate=the speed of a vehicle and the abscissa=passage time and a label based on the set information on the time-series attribute stored in the corresponding information storage section 134 and plots aggregation results on the graph.

In other words, in the image analysis device 1 according to the present embodiment, specific information for each object to be analyzed is allocated to the corresponding information storage section 134 and defined. The information analysis section 126 previously defines general analysis methods such as time-series sort, distribution aggregation, and mean value calculation for data structure which is general-purpose, i.e., independent of an object to be analyzed such as the invariant attribute and the time-series attribute as analysis library. Thereby, the individual processing section 130 designates the combination of the analysis methods and the ordinate and the abscissa of a graph to display a graph automatically converted to specific information on a matter. Thus, specific information for each object to be analyzed can be separated from the function of data analysis.

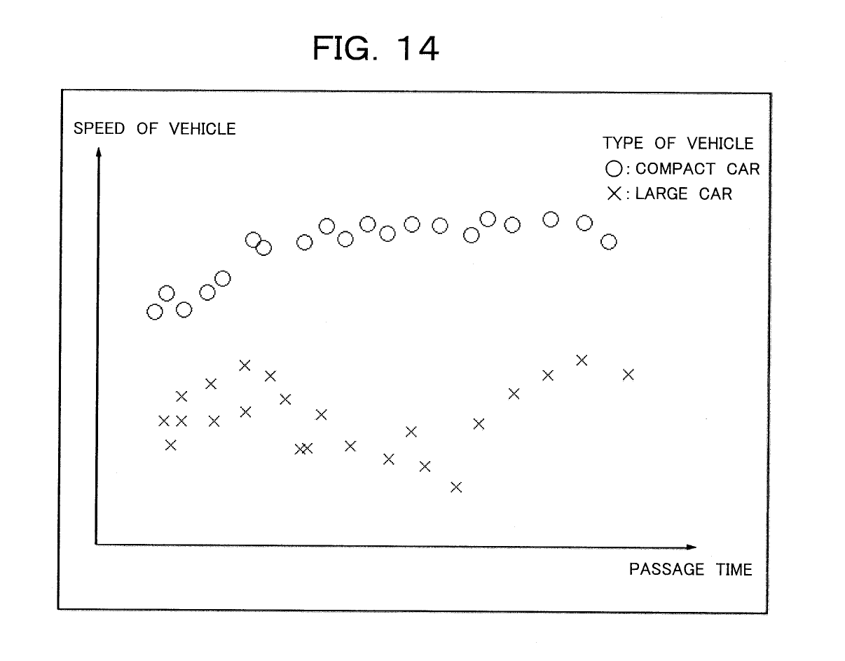

FIG. 14 shows an example of an analysis result display screen. As shown in FIG. 14, Information aggregated in the recognition result analysis processing is plotted on the two-dimensional graph formed of the ordinate and the abscissa determined in the same recognition result analysis processing in the analysis result display screen. For example, in the traffic flow measurement, the type of a vehicle is aggregated as the invariant attribute and the speed of a vehicle is aggregated as the time-series attribute and, in addition, the ordinate is taken as the speed of a vehicle and the abscissa is taken as passage time, so that vehicle speed by vehicle type is plotted in time-series form.

A two-dimensional scatter diagram is used as the type of a graph in the present embodiment, however, a graphic function is not limited in the present embodiment. For example, the number of axes of a graph may be increased to use a three-dimensional graph. The type of a graph may be changed to use a line graph or a bar graph.

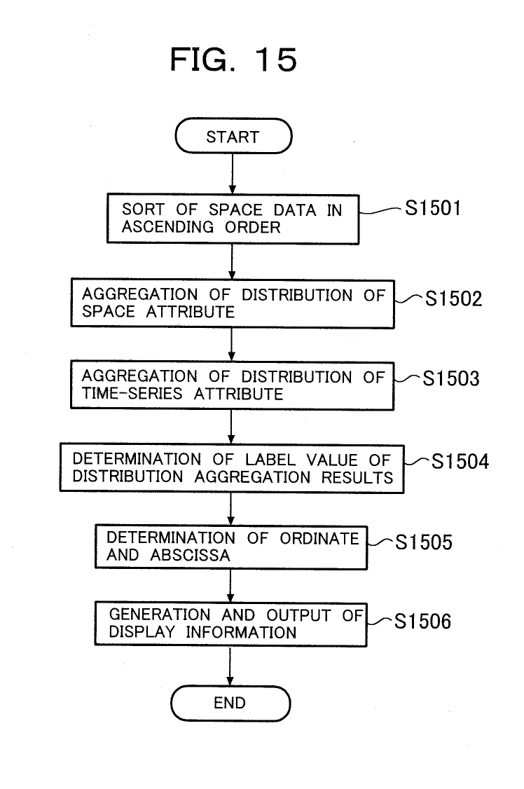

The analysis processing in S908 in FIG. 9 in the case of person monitoring will be described in detail below with reference to FIG. 15. As shown in FIG. 15, in the analysis processing in the case of person monitoring, the space attribute analysis section 126d sorts the information stored in the space information storage section 125 based on the information on space attribute i.e., the information on coordinate (S1501). The space attribute analysis section 126d refers to the space attribute of the information on space sorted in S1501 to aggregate the distribution of the space attribute (S1502). The space attribute analysis section refers to the state ID in order to aggregate the distribution of the time-series attribute and the space attribute of the data by state corresponding to the state ID.

The time-series attribute analysis section 126c refers to the state ID of the space information sorted in S1501 to aggregate the distribution of the time-series attribute of the data by state corresponding to the state ID (S1503). Thereafter, the analysis result acquisition section 135 in the individual processing section 130 acquires the information aggregated in S1502 and S1503. The analysis result output section 136 determines the label value of the distribution aggregation result based on the corresponding information stored in the corresponding information storage section 134 (S1504).

In the case of person monitoring, for example, pieces of specific information to be analyzed being “foot position” and “walk direction” are allocated to the space attribute and the time-series attribute 1 respectively. Therefore, aggregation is made as to which direction each person walks to, from which coordinate to which coordinate in S1502 and S1503. The analysis result output section 136 attaches labels being “foot X coordinate” and “foot Y coordinate” to the aggregation results. The analysis result output section 136 sets the ordinate and the abscissa of the graph (S1505) and outputs information for displaying a graph (S1506) as is the case with the processing described in FIG. 13.

Thus, the image analysis device 1 according to the present embodiment enables sort using space or coordinate value and space distribution aggregation in addition to analysis methods such as time-series sort, distribution aggregation, and mean value calculation. In other words, the analysis method according to the present embodiment includes not only statistical analysis such as aggregation, mean, and variance based on time concept but also spatial concept. In other words, as far as the information analysis section 126 in the image analysis device 1 according to the present embodiment aggregates the information stored in the object information storage section 123, the time information storage section 124, and the space information storage section 125, the information analysis section can realize any of them.

As described above, such an information analysis function is previously provided in the information analysis section 126 and executed by the analysis result acquisition section 135 calling the function for each object to be analyzed. Only the information stored in the object information storage section 123, the time information storage section 124, and the space information storage section 125 is targeted irrespective of an analysis mode, so that the analysis mode is limited and a thinkable analysis mode can be previously set.

Other than that, all the analysis modes are not previously mounted as the function of the information analysis section 126, but the information analysis section 126 is caused to execute principal analysis functions. Less frequently used analysis modes can be added from the individual processing section 130 to the information analysis section 126.

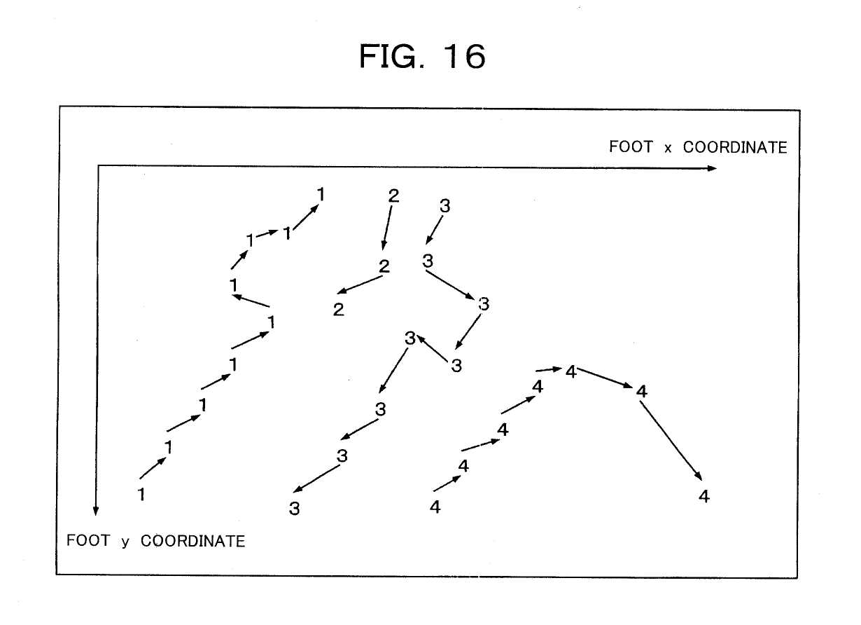

FIG. 16 shows an example of the analysis result display screen in the case of person monitoring. Information aggregated in the recognition result analysis processing is plotted on the two-dimensional graph formed of the ordinate and the abscissa determined in the same recognition result analysis processing in the analysis result display screen in the case of person monitoring.

For example, in the person monitoring, foot position and walk direction as the time-series attribute are aggregated, the ordinate is taken as foot Y coordinate, and the abscissa is taken as foot X coordinate, so that a movement path for each person is plotted. FIG. 16 shows that numerals are IDs of persons and arrows extending from IDs are walk direction.

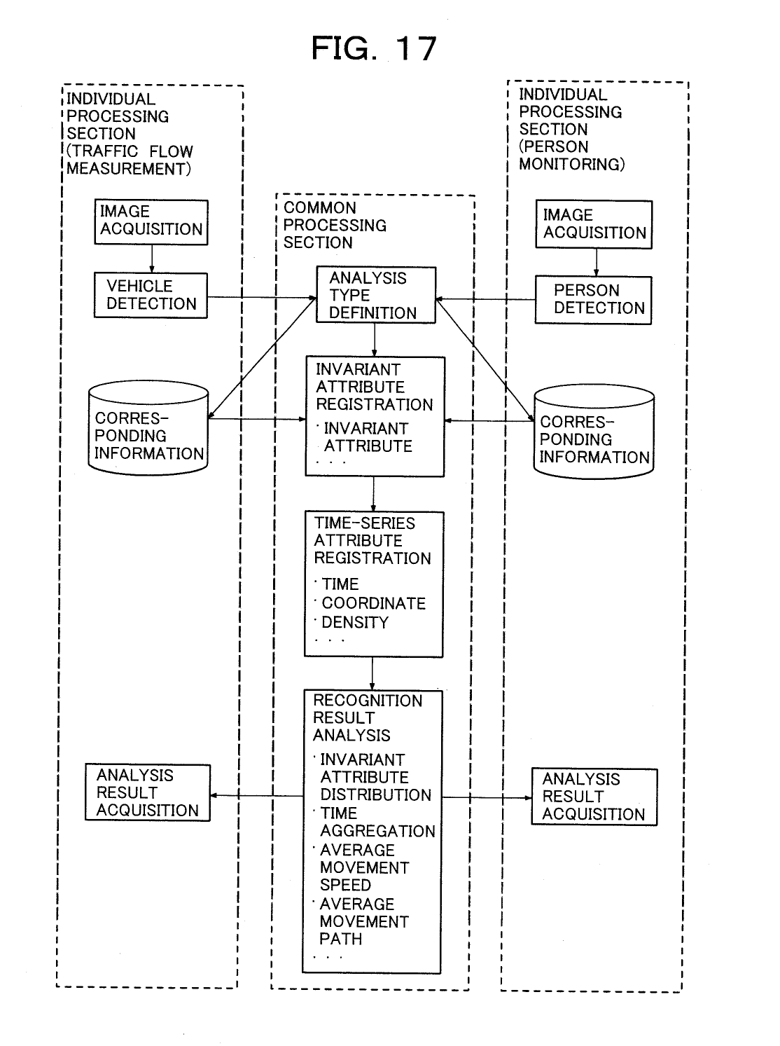

The outline of effects obtained by the present invention is shown in FIG. 17. FIG. 17 shows a block diagram in which the individual processing section 130 and the common processing section 120 are caused to separately oppose a plurality of the individual processing sections 130 as described in FIG. 3. In FIG. 17, an example is shown about the individual processing section 130 for the traffic flow measurement and the person monitoring.

As shown in FIG. 17, the common processing section 120 provides data configuration and data analysis function. In other words, the common processing section 120 functions as a common framework. On the other hand, the individual processing section 130 functions as a recognition application and each of the individual processing sections 130 uses the function provided by the common framework.

Such a configuration allows the common framework developed once to be applied also to the different individual processing section 130. A conventional development method has incurred an unproductive development man-hour because individual development is performed in a case where an object to be analyzed is different. On the other hand, the image analysis device 1 according to the present embodiment can cut down development man-hour because a portion in which individual development is required for each matter to be analyzed can be processed by only the different individual processing section 130 having algorithm specific to the matter such as vehicle or person detection.

On the other hand, a function different in algorithm of image recognition such as vehicle or person detection, in other words, a function depending on an object to be analyzed is individually developed as the different individual processing section 130. If the function depending on an object to be analyzed is included in the common processing section, an object which can be analyzed is limited, so that the image analysis device according to the present embodiment cannot be applied to various objects to be analyzed. On the other hand, the image analysis device 1 can conform to various objects to be analyzed by separately providing the function depending on an object to be analyzed as the individual processing section 130 and developing the individual processing section 130 corresponding to the input and output of information among the information management section 122, the analysis type definition section 121 and the information analysis section 126 for each object to be analyzed.

In the present embodiment, a configuration is employed such that an object, time, and space are associated with one another as independent information. The present embodiment provides both of a sorting method with time as a reference and a sorting method with space as a reference as a recognition result analysis function. Thereby, an effect can also be acquired in which recognition results can be quickly aggregated even in a business matter with a time-series variation analysis such as traffic flow measurement as a main purpose or even in a business matter with a space distribution analysis such as marketing using person-flow measurement as a main purpose.

In a computer environment for executing the processing according to the present invention, the present embodiment may be realized by dividing any one of processing means in the present embodiment into two or more processing means or may be realized by integrating any two or more processing means as one processing means. The present embodiment does not restrict a mode to be realized as far as the function provided by the present invention is not impaired.

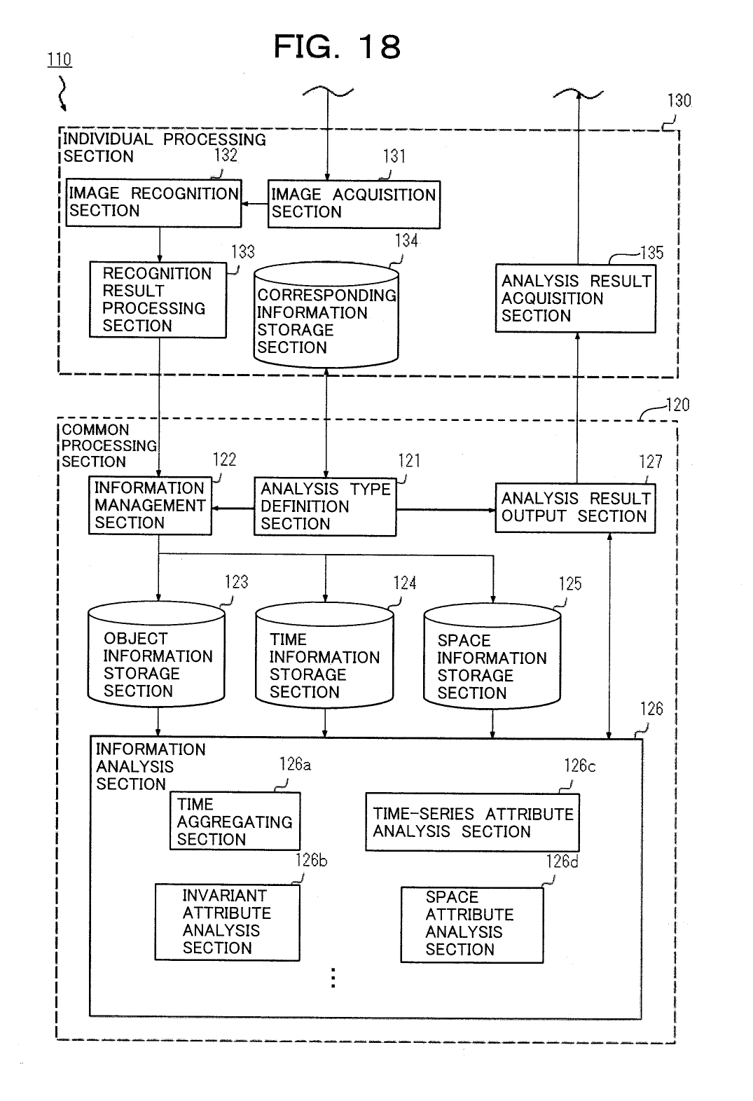

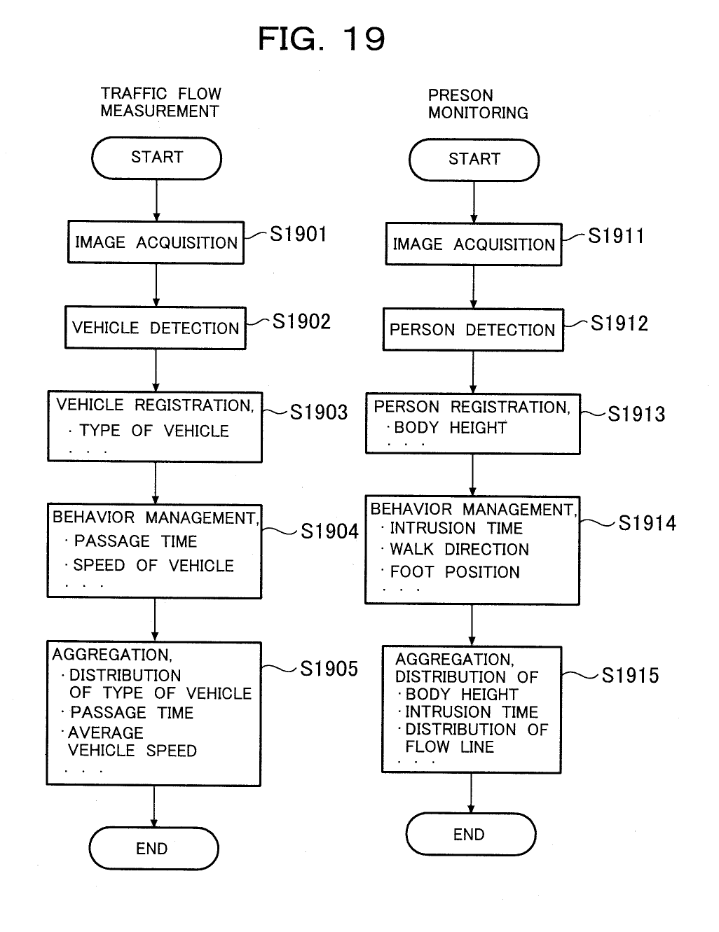

In the present embodiment, as shown in FIG. 3, a case where the analysis result output section 136 is included in the individual processing section 130 and display information is generated in the individual processing section 130 is described as an example. Other than that, as shown in FIG. 18, an analysis result output section 127 may be provided in the common processing section 120. This allows further cutting down a function to be individually developed as the individual processing section 130.

### REFERENCE SIGNS LIST

1 Image analysis device
10 CPU
11 RAM
12 ROM
13 IMAGE INPUT SECTION
14 HDD
15 I/F
16 LCD
17 OPERATION SECTION
18 BUS
100 CONTROLLER
101 MAIN CONTROL SECTION
102 DEVICE DRIVER
110 IMAGE ANALYSIS SECTION
120 COMMON PROCESSING SECTION
121 ANALYSIS TYPE DEFINITION SECTION
122 INFORMATION MANAGEMENT SECTION
123 OBJECT INFORMATION STORAGE SECTION
124 TIME INFORMATION STORAGE SECTION
125 SPACE INFORMATION STORAGE SECTION
126 INFORMATION ANALYSIS SECTION
126a TIME AGGREGATING SECTION
126b INVARIANT ATTRIBUTE ANALYSIS SECTION
126c TIME-SERIES ATTRIBUTE ANALYSIS SECTION
126d SPACE ATTRIBUTE ANALYSIS SECTION
130 INDIVIDUAL PROCESSING SECTION
131 IMAGE ACQUISITION SECTION
132 IMAGE RECOGNITION SECTION
133 RECOGNITION RESULT PROCESSING SECTION
134 CORRESPONDING INFORMATION STORAGE SECTION
135 ANALYSIS RESULT ACQUISITION SECTION
136 ANALYSIS RESULT OUTPUT SECTION

1. An image analysis device for analyzing information on input moving image to output a result of an analysis, the image analysis device comprising:
an individual processing section configured to perform processing according to an object to be analyzed to recognize an object included in the moving image; and
a common processing section configured to subject a plurality of different objects to be analyzed to a common analysis processing based on the results recognized by the individual processing section;
wherein the individual processing section includes:
an information extraction section configured to recognize the object included in the moving image according to the object to be analyzed to extract information;
a corresponding information storage section configured to store corresponding information showing to which information processed in the common processing section the extracted information corresponds; and
a processing result acquisition section configured to acquire the information analyzed and processed by the common processing section; and
wherein the common processing section includes:
an object information storage section configured to store object identification information for identifying the object and information on a state of the object which are associated with each other;
a time information storage section configured to store the information on the state of the object and time information being information on time during which the object is in the state which are associated with each other;
a position information storage section configured to store the information on the state of the object and position information showing a position where the object exists in the state which are associated with each other;
an information management section configured to store the extracted information in at least one of the object information storage section, the time information storage section, and the position information storage section based on the corresponding information; and
an information analysis section configured to analyze information stored in the object information storage section, the time information storage section, and the position information storage section.

2. The image analysis device according to claim 1,
wherein: the object information storage section stores state identification information for identifying a plurality of states of the object changing in time series as information on the state of the object;
the time information storage section stores the state identification information and information on time during which the object is in the state identified by the state identification information which are associated with each other; and
the position information storage section stores the state identification information and information on position where the object exists in the state identified by the state identification information which are association with each other.

3. The image analysis device according to claim 1,
wherein: the object information storage section stores information on a time-series attribute of the object being successively changed as information on the state of the object; and
the information analysis section analyses the information on the time-series attribute based on at least one of the information on time and the information on position.

4. The image analysis device according to claim 3, wherein the information analysis section analyses change in information on the time-series attribute according to change in at least one of the information on time and the information on position.

5. The image analysis device according to claim 1,
wherein: the object information storage section stores information on an invariant attribute of the object being successively invariant as information on the state of the object; and
the information analysis section analyses information on the invariant attribute based on at least one of the information on time and the information on position.

6. The image analysis device according to claim 5, wherein the information analysis section analyses distribution of information on the invariant attribute according to change in at least one of the information on time and the information on position.

7. The image analysis device according to claim 1,
wherein: the time information storage section stores the information on time and the object identification information which are associated with each other; and
the information analysis section sorts the information stored in the time information storage section based on the information on time and analyzes the information stored in the object information storage section based on the object identification information associated with the sorted information on time.

8. The image analysis device according to claim 1,
wherein: the space information storage section stores the information on space and the object identification information which are associated with each other; and
the information analysis section sorts the information stored in the space information storage section based on the information on space and analyzes the information stored in the object information storage section based on the object identification information associated with the sorted information on space.

9. The image analysis device according to claim 1,
wherein: the time information storage section can store information on time in the moving image and actual time as information on time; and
if both the time in the moving image and the actual time exist in the time information storage section, the information analysis section performs conversion to at least one of formats and performs analysis.

10. The image analysis device according to claim 1,
wherein: the position information storage section can store information on position in the moving image and actual position as information on position; and
if both the position in the moving image and the actual position exist in the position information storage section, the information analysis section performs conversion to at least one of formats and performs analysis.

11. The image analysis device according to claim 1, wherein the information analysis section has a function to aggregate the number of objects identified by the object identification information stored in the object information storage section.

12. The image analysis device according to claim 1, further comprising a display information generation section configured to generate display information for visually displaying the results analyzed by the information analysis section.

13. An image analysis program for analyzing information on input moving image to output a result of an analysis, the image analysis program causing an information processing device to execute:
an individual processing step of performing processing according to an object to be analyzed to recognize objects included in the moving image; and
a common processing step of subjecting a plurality of different objects to be analyzed to a common analysis processing based on the results recognized by the individual processing section;
wherein the individual processing step includes:
a step of recognizing the object included in the moving image according to the object to be analyzed to extract information;
a corresponding information providing step of providing corresponding information showing to which information processed in the common processing step the extracted information corresponds; and
a process result acquisition step of acquiring the information analyzed and processed by the common processing section; and
wherein the common processing step includes:
a step of storing the extracted information in an object information storage section configured to store object identification information for identifying the object and information on the state of the object which are associated with each other, a time information storage section configured to store the information on the state of the object and time information being information on time during which the object is in the state which are associated with each other, and a position information storage section configured to store the information on the state of the object and position information showing a position where the object exists in the state which are associated with each other based on the corresponding information; and
an information analysis step of analyzing information stored in the object information storage section, the time information storage section, and the position information storage section.
